(19) United States
(12) Patent Application Publication
(10) Pub. No.: US 2009/0134799 A1
(43) Pub. Date: May 28, 2009

(54) DISCHARGE LAMP, ELECTRODE, AND METHOD OF MANUFACTURING A COMPONENT OF A DISCHARGE LAMP

(75) Inventors: Erik Jacobus Marinus Houet, Eindhoven (NL); Nina Huck, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,005

(22) PCT Filed: Oct. 26, 2005
(86) PCT No.: PCT/IB05/53503

§ 371 Date: Apr. 26, 2007

(30) Foreign Application Priority Data
Nov. 2, 2004 (EP) 04105460.2

(51) Int. Cl. H01J 61/04; H01J 9/02; C04B 35/00

(52) U.S. Cl. 313/631; 445/46; 264/104

(57) ABSTRACT

The invention relates to a discharge lamp comprising a sealed bulb that accommodates two electrodes (3) of refractory material positioned opposite to each other. At least one of said electrodes comprises at least a portion (4) of reshaped extruded refractory material. Accordingly, an extruded product (P) can be provided with a complicated shape. The invention also relates to an electrode and a method of manufacturing at least a portion (4) of an electrically conductive component for a discharge lamp, in particular a HID or UHP lamp.

The invention relates to a discharge lamp, an electrode, and a method of manufacturing of a component of such a discharge lamp.

Discharge lamps typically comprise two electrodes positioned opposite to each other in a sealed transparent and/or translucent bulb filled with gas. In operation, current is provided to these electrodes, which results in a pronounced heating of the electrodes. Consequently, thermal design of the electrodes is an important issue in preventing an early failure of the lamps during operation.

Conventionally, electrodes were produced by coiling a drawn wire around a drawn rod. The coiled wire is provided to have a thermal mass available to dissipate a quantity of heat at the tip portion of the electrode.

More recently, extrusion and metal injection molding (MIM) have emerged as methods of manufacturing electrodes in response to higher requirements imposed by more sophisticated lamps, such as high intensity discharge (HID) lamps and ultra high pressure (UHP) lamps. Extrusion involves the pressing of a mixture of a powder, a solvent, and a binder through a die to obtain an extruded product, followed by sintering of this product. Extrusion allows a two-dimensional freedom in shaping of the electrode. U.S. Pat. No. 6,218,025 discloses an electrode manufactured in a MIM process. MIM involves casting of a material in a mold that is specifically designed for the required shape of the electrode. The molded (“green”) product is subsequently sintered. This technique provides freedom in three dimensions, dictated by the mold, in obtaining an electrode. A MIM product typically has a seam resulting from the injection mold.

Complex shapes are required for such electrodes in order to increase their functionality as regards characteristics such as thermal mass, arc stability, and ignition. Extrusion, however, has a limited shaping freedom, while MIM requires complex and expensive dedicated molds.

An alternative to these approaches is disclosed in JP 2001-319615, wherein a tip of a cathode has a hole filled with an emitter-containing layer. The cathode is subsequently sintered and afterwards machined into a cone shape. However, machining of the sintered electrode may be difficult and is limited to the portion of the electrode that is free from the emitter-containing layer.

It is an object of the invention to provide a lamp and an electrode that can be manufactured by an alternative technique that reduces or eliminates one or more of the above-mentioned disadvantages.

This object is achieved by a discharge lamp comprising a sealed transparent bulb accommodating two electrodes of refractory material positioned opposite to each other, wherein at least one of said electrodes comprises at least a portion made of a reshaped extruded refractory material.

This object is further achieved by an electrode for a discharge lamp comprising a portion made of a reshaped extruded refractory material.

This object is also achieved by a method of manufacturing at least a portion of an electrically conductive component for a discharge lamp, comprising the steps of:

extruding a mixture comprising a binder and a powder of refractory material through a die so as to obtain an extruded product;

reshaping said extruded product so as to obtain an appropriate shape for said portion of said component, and subsequently sintering said portion.

The limitation to two dimensions in the shaping of the component is eliminated or reduced in that the manufacturing process for the lamp component is interrupted at an appropriate stage after extrusion to allow reshaping, whereupon the manufacturing process is finalized with at least one sintering step. Furthermore, no expensive and complicated dedicated molds are required. Finally, extrusion allows the refractory material to contain a considerable amount of emitter material that can be reshaped in an appropriate reshaping process before sintering. It should be appreciated, however, that emitter material is not necessarily present in an electrode for a discharge lamp. The lamp component is preferably an electrode, but other electrically conductive lamp components, such as a feed-through for providing the current to or from the electrodes in the sealed bulb, are envisaged as well.

The embodiment of the invention as defined in claims 2 and 8 has the advantage that only the portion of the electrode that requires the special shape may be manufactured by interrupting the extrusion process. The other portion may be, for example, a drawn wire.

In the special embodiment of the invention defined in claims 3 and 4, a lamp with a well-defined electrode tip is obtained having improved arc stability and ignition.

The embodiment of the invention defined in claims 5 and 9 has the advantage that the ignition process is facilitated by the higher emitter concentration. For drawn wires, this concentration is typically limited as otherwise drawing of the wires becomes impossible as a result of the inability of the emitter material to deform.

The embodiment of the invention as defined in claims 11 and 12 provides the advantage of facilitating the reshaping process by a temporary weakening of the binder of the extruded product. More preferably, the solvent is applied selectively only so as to maintain a stable overall extruded product in the green phase.

The embodiment of the invention as defined in claim 13 has the advantage that deformation of the extruded product in the green phase is relatively easy.

The embodiment of the invention as defined in claim 15 has the advantage that the hole provides a space to receive residual material not needed for the desired shape of the electrode.

The invention will be further illustrated with reference to the attached drawings, which schematically show preferred embodiments according to the invention. It will be understood that the invention is not in any way restricted to these specific and preferred embodiments.

In the drawings:

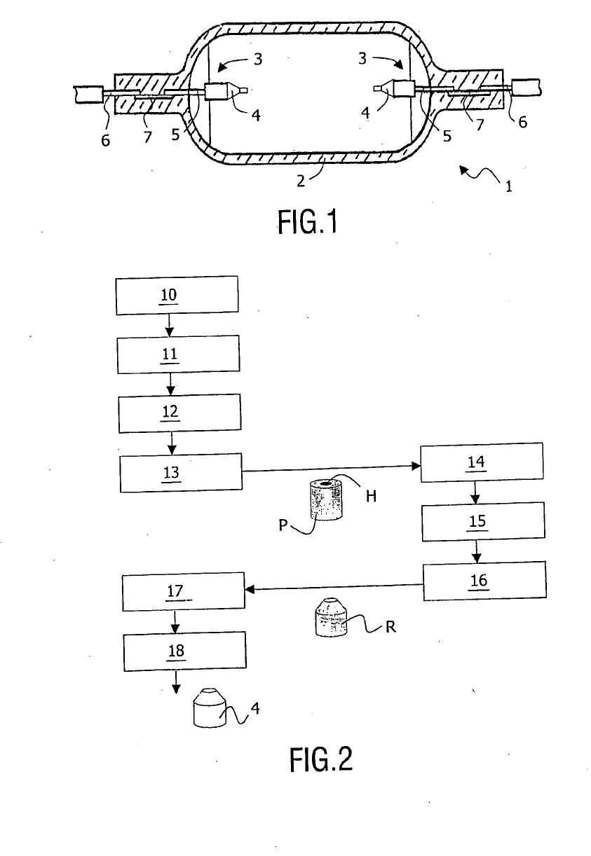

FIG. 1 shows a schematic illustration of a discharge lamp;

FIG. 2 is a flowchart of method steps according to an embodiment of the invention for obtaining a discharge lamp electrode;

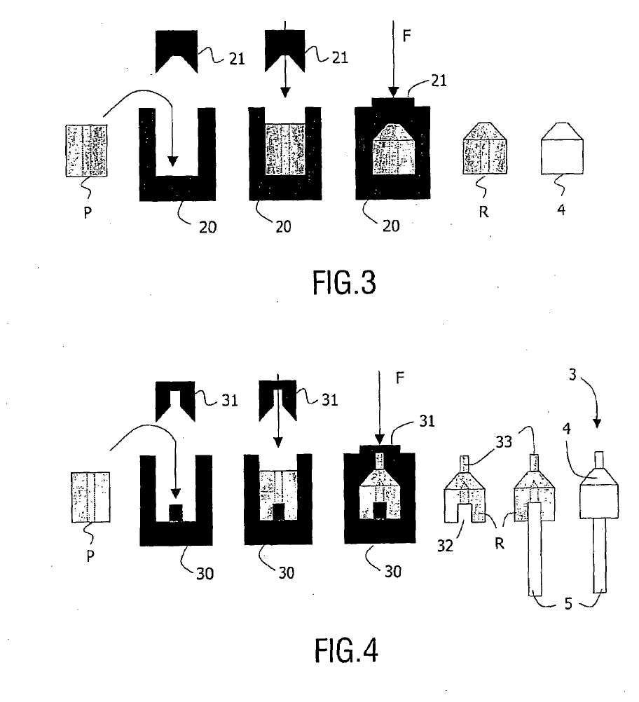

FIG. 3 illustrates various steps for manufacturing a first embodiment of an electrode portion according to the invention, and

FIG. 4 illustrates various manufacturing steps for a second embodiment of an electrode portion according to the invention.

FIG. 1 shows an AC discharge lamp 1, such as a high intensity discharge (HID) lamp or a ultra high pressure (UHP) discharge lamp, hereinafter referred to as lamp 1. The lamp 1 has a sealed, transparent or translucent bulb 2 that forms a discharge chamber accommodating electrodes 3, each with a reshaped extruded portion 4 and an elongate portion 5, i.e. an electrode 3 with a well-defined electrode tip. Current can be fed to and from the electrodes 3 via leads 6 and feed-throughs 7.

FIG. 2 is a flowchart of manufacturing steps for an electrode 3.

In step 10, a mixture is provided of a powder of refractory material such as tungsten, a solvent such as an alcohol and a binder such as methyl cellulose. The mixture may further comprise an electron emitter substance such as a rare-earth oxide or carbide in an amount of 2 to −40 vol. %. This mixture is pressed through a die with a pin (not shown) in step 11, such that an elongate intermediate product is obtained. The solvent is subsequently removed from the intermediate product in step 12 to have a strong product that is appropriate to handle. The product in this stage is commonly referred to as the green product. In step 13, the green product is cut into pieces of appropriate size to obtain the extruded product P. The extruded product has a through hole H caused by the pin of the extrusion die.

At this stage, one or more sintering steps, i.e. heating of the extruded product to a temperature at which the powder particles merge with each other to obtain a fully dense product, are conventionally applied. The binder is removed during sintering, and strength is built up during the temperature step. According to the invention, however, this process is interrupted by a reshaping step.

In step 14 applied to the embodiment of FIG. 2, a solvent, such as an alcohol, is selectively added to the extruded product P in places where reshaping of the extruded product P is intended. The binder is temporarily weakened thereby. The positionally selective addition of the solvent is achieved, for example, by dipping only the relevant portion of the extruded product P in the solvent.

Then, in step 15, the weakened portion of the extruded product P is reshaped under pressure to obtain a reshaped extruded product R of refractory material for the electrode 3. The hole H provides a space for receiving residual material resulting from the reshaping process. The hole H may have a slightly flattened tip after reshaping. In step 16, the solvent is removed from the reshaped extruded product R.

Finally, the conventional process of sintering is resumed, comprising a pre-sintering step 17 at a temperature of e.g. 1000-1200° C. to remove the binder and a sintering step 18 at 2000-2600° C. to obtain a fully dense portion 4 of reshaped extruded refractory material for the electrode 3 of FIG. 1.

FIG. 3 illustrates various steps of FIG. 2 for obtaining a portion 4 of reshaped extruded refractory material for the electrode 3. Such a portion 4 may be used for an electrode 3 of a HID lamp 1. From left to right in FIG. 3, the extruded product P with a selectively added solvent at the top portion is provided in a mold 20. Then, the extruded product P is deformed under pressure by a pressing tool 21 with a force F compressing the extruded product P. The reshaped product R may subsequently be sintered according to steps 17 and 18 of FIG. 2 to obtain the portion 4 for the electrode 3. This portion 4 is designed for a HID electrode with a shape that enhances arc stability during stable operation.

FIG. 4 illustrates various steps of FIG. 2 for obtaining another portion 4 of reshaped extruded refractory material in combination with an elongate portion 5 of drawn wire for an electrode 3 shown in FIG. 1. The elongate portion 5 may also be manufactured by extrusion, which generally is a cleaner process than wire drawing. Again, the selectively weakened extruded product is provided in a mold 30 and exposed to an compression force F by a pressing tool 31 to obtain the reshaped product R. The reshaped product R has a recess 32 and a protrusion 33. Subsequently the elongate portion 5 of drawn wire is inserted into the recess 32 of the reshaped product R, whereupon the sintering steps 17 and 18 are executed. Consequently, shrinkage of the reshaped product R causes the elongate portion 5 to fix itself in the hole 32. The protrusion 33 is in fact an extension of the elongate portion 5, as the elongate portion ends within the recess 32 while the protrusion 33 is aligned with the elongate portion 5 further along the portion 4. An electrode 3 with a well-defined tip portion is obtained for a UHP discharge lamp 1 of FIG. 1.

It should be noted that the above-mentioned embodiments illustrate rather than limit the invention, and that those skilled in the art will be able to design many alternative embodiments without departing from the scope of the appended claims. As an example, the feed-throughs 7, e.g. made of molybdenum, may be manufactured by the method according to the invention. More generally, it should be appreciated that the method according to the invention may also be applied to products other than lamp components. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. A discharge lamp (1) comprising a sealed transparent bulb (2) that accommodates two electrodes (3) of refractory material positioned opposite to each other, wherein at least one of said electrodes comprises at least a portion (4) made of a reshaped extruded refractory material.

2. The discharge lamp (1) according to claim 1, wherein said electrode comprises a further portion (5) that is electrically connected to said reshaped extruded portion (4).

3. The discharge lamp (I) according to claim 2, wherein said discharge lamp is an ultra high pressure lamp, and said electrode (3) comprises a elongate portion (5) inserted into a recess (32) of said reshaped extruded portion (4).

4. The discharge lamp (1) according to claim 3, wherein said reshaped extruded portion (4) has a protrusion (33) forming an extension of said elongate portion (5).

5. The discharge lamp (1) according to claim 1, wherein said extruded electrode is made of tungsten and comprises more than 2 mole percent of electron emitter dopant.

6. The discharge lamp (1) according to claim 1, wherein said discharge lamp is a high intensity discharge lamp or an ultra high pressure discharge lamp.

7. A method of manufacturing at least a portion (4) of an electrically conductive component (3, 7) for a discharge lamp (1), comprising the steps of:
extruding a mixture comprising a binder and a powder of refractory material through a die so as to obtain an extruded product (P);
reshaping said extruded product (P) so as to obtain an appropriate shape for said portion (4) of said component (3, 7) and subsequently sintering said portion (4).

8. The method according to claim 7, wherein method further includes the step of adding a solvent to said extruded product (P).

9. The method according to claim 8, wherein said solvent is added selectively to said extruded product (P).

10. The method according to claim 7, wherein said reshaping is performed by deforming said extruded product (P) under pressure.

11. The method according to claim 7, wherein said component is an electrode (3) or a feed-through (7) of said discharge lamp.

12. The method according to claim 7, wherein said die comprises a pin for obtaining a hole (H) in said extruded product (P)
